(19) United States
(12) Patent Application Publication
(10) Pub. No.: US 2026/0008128 A1
(43) Pub. Date: Jan. 8, 2026

(54) DEVICE FOR THE COLLECTIVE TREATMENT OF SURFACES OF A PLURALITY OF OBJECTS

(71) Applicant: SLCR-Lasentechnik GmbH, Langerwehe (DE)

(72) Inventor: Olav G. SCHULZ-GAUS, Bergheim (DE)

(73) Assignee: SZCR-Lasertchnik GmbH, Langerwehe (DE)

(21) Appl. No.: 19/254,550

(22) Filed: Jun. 30, 2025

(30) Foreign Application Priority Data
Jul. 4, 2024 (DE) 202024103668.9

(51) Int. Cl. B23K 26/352; B23K 26/08

(52) U.S. Cl. CPC B23K 26/3584; B23K 26/083; B23K 26/0869

(57) ABSTRACT

The present invention relates to a device for the collective treatment of surfaces of a plurality of objects, comprising a receiving unit having a rotatable drum defining a receiving space for receiving objects to be treated and an irradiation unit which is arranged and designed to introduce radiation into the receiving space of the drum and thus to treat surfaces of the objects introduced into the receiving space, wherein the irradiation unit is held on an articulated arm robot or on a multi-axis linear system and is movable relative to the receiving unit.

### CROSS-REFERENCE TO RELATED APPLICATIONS AND CLAIM TO PRIORITY

This application is related to utility model application no. 20 2024 103 668.9, filed Jul. 4, 2024 in Germany, the complete disclosure of which is incorporated herein by reference and to which priority is claimed.

### FIELD OF THE INVENTION

The present invention relates to a device for the collective treatment of surfaces of a plurality of objects.

### BACKGROUND OF THE INVENTION

Such devices are generally known. They are primarily used to simultaneously clean, roughen, or similarly treat the surfaces of a plurality of components. A device known from EP 3 932 572 A1 has a receiving unit that defines a receiving space where the objects to be treated are put in bulk. There is also an irradiation unit to irradiate the objects received in the receiving space with laser radiation. The components to be irradiated are mixed by moving the receiving unit as a whole or a drum of the receiving unit that receives the bulk material.

It has been shown that very good cleaning results can be achieved with the known device. However, efforts are being made to further improve the quality of the treatment.

Against this background, it is an object of the present application to provide a device for the collective treatment of surfaces of a plurality of objects of the type mentioned above with an improved design.

### SUMMARY OF THE INVENTION

To solve this object, the present invention provides a device for the collective treatment of surfaces of a plurality of objects, comprising a receiving unit with a drum which forms a receiving space accessible through an upper drum opening for receiving objects to be treated, a drum holder into which the drum can be inserted, a drive unit designed to drive the drum inserted into the drum holder in rotation about an axis of rotation relative to the drum holder, and a pivoting unit holding the drum holder, which is designed to arrange the drum holder in different pivoting positions by pivoting it about a pivot axis, the pivoting positions comprising a loading position, in which the drum can be inserted vertically from above into the drum holder and removed vertically upwards from it, and a working position, in which the drum holder is tilted relative to the loading position by a first pivoting angle to the vertical, which is in particular in a range between 30° and 60°, and an irradiation unit which is arranged and designed to introduce radiation into the receiving space of the drum received in the drum holder in the working position of the drum holder and thus to treat surfaces of the objects introduced into the receiving space, wherein the irradiation unit is held on an articulated arm robot or on a multi-axis linear system and is movable relative to the receiving unit.

In the loading position, the drum can be inserted into the drum holder from above, for example using a crane, with the objects held therein. Alternatively, the drum held in the drum holder can be filled with the objects in the loading position, for example via a chute or the like. After the drum has been moved into the working position by pivoting the drum holder about the pivot axis, the objects can then be cleaned using the irradiation unit, which irradiates the objects through the drum opening while the drum is rotated about the axis of rotation, in particular in a tumbling motion, in order to mix the objects. Thanks to the arrangement of the irradiation unit on an articulated arm robot or on a multi-axis linear system, it can be optimally aligned with the drum, thereby achieving optimum treatment quality of the bulk material. The alignment of the irradiation unit relative to the drum can also be changed during processing, which can also be beneficial for process optimization. After completion of the treatment, the drum holder is returned to its loading position, then the drum with the treated objects is removed and replaced by a drum with new objects to be treated. Overall, this enables a very effective method for the collective treatment of surfaces of a large number of objects.

The treatment is preferably is a surface cleaning and/or surface roughening treatment, which serves in particular to prepare the object surfaces for a subsequent surface coating process.

The objects are preferably bulk goods, in particular metallic bulk goods, for example in the form of small metal parts such as screws, nuts, clips, fittings, or the like.

According to one embodiment of the present invention, the axis of rotation runs centrally through the drum opening of the drum inserted into the drum holder and, in particular, is aligned perpendicular to a plane of the drum opening.

The pivot axis extends advantageously horizontally.

The pivot axis and the axis of rotation are preferably perpendicular to each other.

According to one embodiment of the present invention, the pivoting positions comprise an unloading position in which the drum holder is tilted relative to the loading position by a second pivoting angle to the vertical, wherein the second pivoting angle lies in particular in a range between 150° and 210°. When the drum is moved to the unloading position, objects held in the drum are simply dumped.

Advantageously, the irradiation unit has at least one radiation source, which is designed in particular as a laser beam source.

Preferably, each radiation source comprises an associated optical system.

Advantageously, the receiving unit has an extraction unit for extracting process vapors from the receiving space of the drum received in the drum holder, thereby improving the work result and work safety.

Preferably, the device has a protective cabin accessible from above, inside which the receiving unit, the irradiation unit, and the articulated arm robot are arranged.

With regard to further embodiments of the invention, reference is made to the following description of the embodiments with reference to the accompanying drawing.

### BRIEF DESCRIPTION OF THE DRAWINGS

In the drawings

FIG. 1 is a schematic front view of a device according to a first embodiment of the present invention, which is used for the collective treatment of surfaces of a plurality of objects, wherein a drum containing objects to be processed is inserted into a drum holder arranged in a loading position;

FIG. 2 is a schematic front view of the device shown in FIG. 1, in which the drum is received in the drum holder;

FIG. 3 is a schematic front view of the device shown in FIG. 1 during surface treatment, with the drum holder in a working position;

FIG. 4 is a schematic front view of the device shown in FIG. 1, wherein the drum holder is in an unloading position; and

FIG. 5 is a schematic front view of a device according to a second embodiment of the present invention, which is used for the collective treatment of surfaces of a plurality of objects, wherein a drum holder is in a working position.

The same reference numbers refer to the same or similar components.

### DETAILED DESCRIPTION OF THE PREFERRED EMBODIMENT(S)

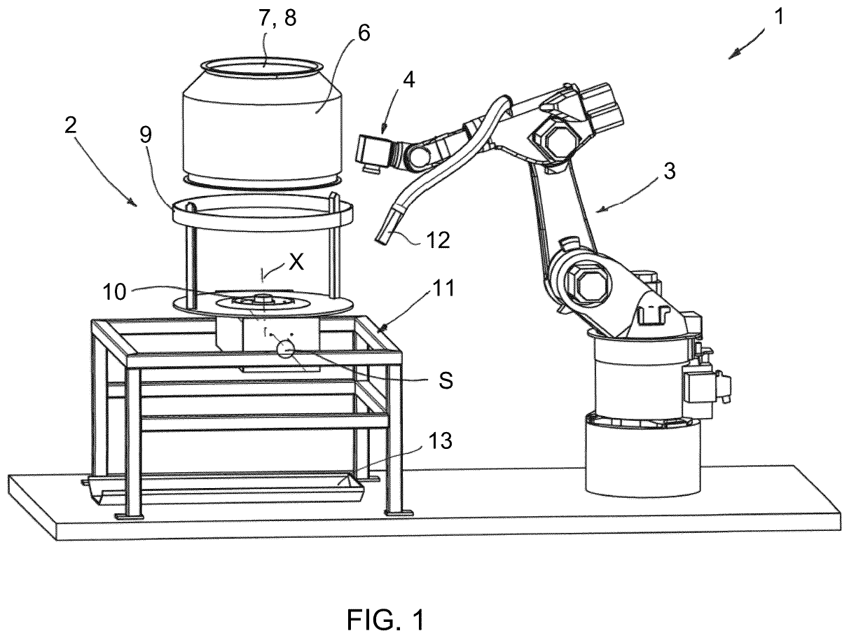

FIGS. 1 to 4 show an embodiment of a device 1 according to the invention for the collective treatment of surfaces of a plurality of objects. More specifically, the apparatus 1 is used for surface treatment of, in particular, metallic bulk material in the form of screws, nuts, clips, fittings or other small parts. The aim of the treatment is, in particular, to clean and/or roughen and/or deburr the object surfaces. The device 1 comprises, as main components, a receiving unit 2 and an irradiation unit 4 held on an articulated arm robot 3, which are preferably arranged in a protective cabin or the like, even if this is not shown here.

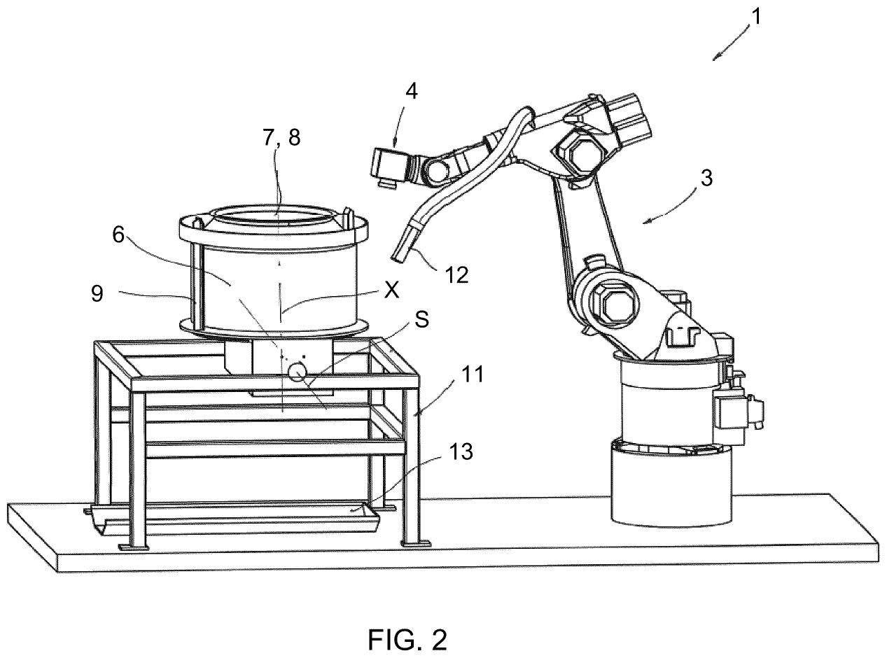

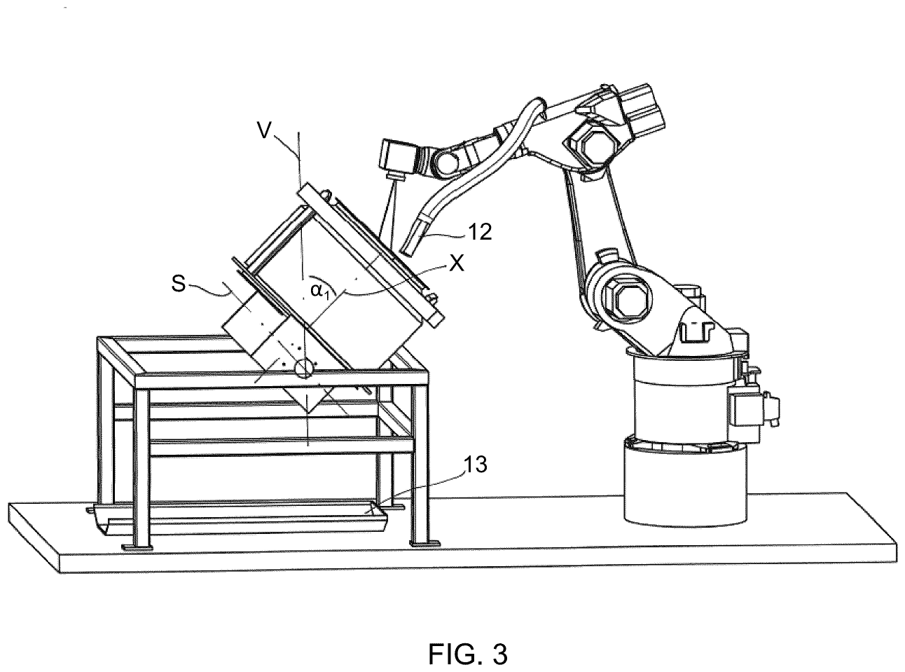

The receiving unit 2 has a drum 6 which forms a receiving space 8 accessible through an upper drum opening 7 and which serves to receive objects to be treated. The receiving unit 2 further comprises a drum holder 9 into which the drum 6 can be inserted, and a drive unit 10 with which the drum 6 inserted into the drum holder 9 can be rotated and/or rotated in a tumbling manner about an axis of rotation X relative to the drum holder 9. In the present embodiment, the axis of rotation X runs centrally through the drum opening 7 of the drum 6 inserted into the drum holder 9 and is aligned in particular perpendicular to a plane of the drum opening 7. Drive units suitable for this purpose are generally known in the prior art and are therefore not described in detail here. For example, drive wheels positioned around the inside of the drum holder 9 can be used to drive the drum 6 in rotation. In addition, the receiving unit 2 has a pivoting unit 11 on which the drum holder 9 is held so that it can be pivoted about a pivot axis S extending horizontally and perpendicular to the axis of rotation X. The pivoting unit 11 is designed to move the drum holder 9 between a loading position, in which the drum 6 can be inserted vertically from above into the drum holder 9 and removed vertically from it, as shown in FIGS. 1 and 2, and a working position shown in FIG. 3, in which the drum holder 9 is tilted relative to the loading position by a pivoting angle α₁ to the vertical V, and an unloading position, in which the drum holder 9 is tilted relative to the loading position by a second pivoting angle α₂ to the vertical V. The first pivoting angle α₁ is preferably in a range between 30° and 60°, the second pivoting angle α₂ preferably lies in a range between 150° and 210°. A further component of the device 1 is an extraction unit 12, which is designed to extract process vapors from the receiving space 8 of the drum 6 received in the drum holder 9.

The irradiation unit 4 is designed to introduce radiation into the drum space 8 of the drum 6 held in the drum holder 9 through the drum opening 7 when the drum holder 9 is in the working position, thereby treating objects placed in the receiving space 8. In the embodiment shown, the irradiation unit 4 comprises a laser beam device in the form of a laser head. Furthermore, the irradiation unit 4 may additionally have an optical system assigned to the laser head.

The articulated arm robot 3 preferably has seven axes of movement so that the irradiation unit 4 held on it can be moved freely relative to the drum 6 or drum opening 7.

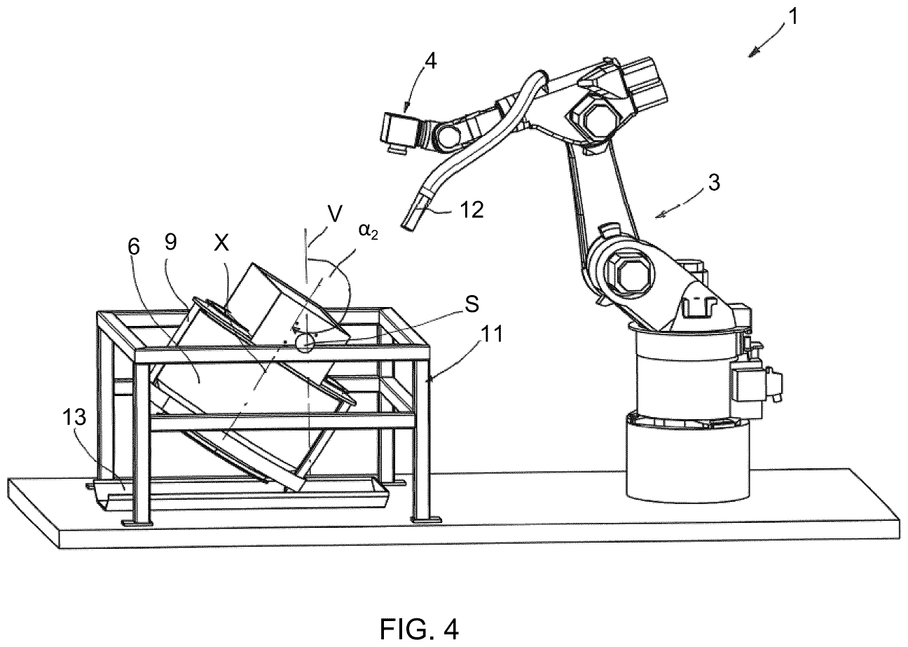

To treat objects, they are first introduced as bulk material into the receiving space 8 of the drum 6. The drum 6 is then inserted vertically from above into the drum holder 9 arranged in its loading position, for example using a crane, as shown in FIGS. 1 and 2. The drum 6 is then moved into its working position shown in FIG. 3 by pivoting the drum holder 9 about the swivel axis S, and the irradiation unit 4 is aligned relative to the drum 6 or the drum opening 7 using the articulated arm robot 3 in such a way so that the radiation emitted by the irradiation unit 4 is directed onto the objects arranged in the receiving space 8 of the drum 6. The objects are then cleaned using the irradiation unit 4, while the drum is rotated about the axis of rotation X, in particular in a tumbling motion, to mix the objects. After completion of the treatment, the drum holder 9 is returned to its loading position, then the drum 6 with the treated objects is removed and replaced by a drum 6 with new objects to be treated. Alternatively, the processed components can be dumped out of the drum 6 into a trough 13, for example, by moving the drum holder 9 to the unloading position shown in FIG. 4. The drum 6 can then be either replaced in the feed position of the drum holder 9 or filled with new objects, for example via a chute not shown in detail. Overall, this provides a very effective method for the collective treatment of the surfaces of a large number of objects.

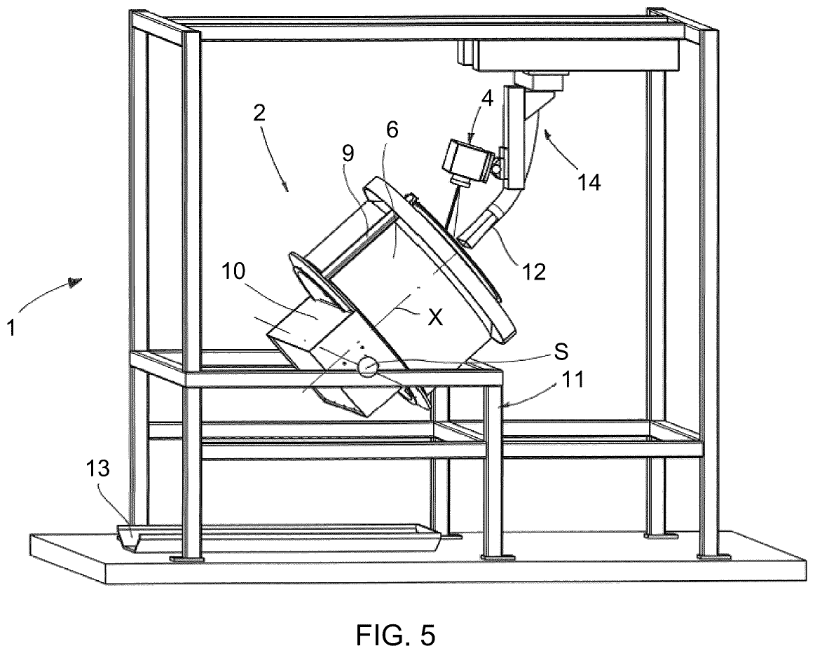

FIG. 5 shows a device 1 according to a further embodiment of the present invention, which differs from the previously described embodiment primarily in that the irradiation unit 4 is not moved by an articulated arm robot 3 but by a multi-axis linear system 14.

1. Device (1) for the collective treatment of surfaces of a plurality of objects, comprising
a receiving unit (2) with a drum (6) which forms a receiving space (8) accessible through an upper drum opening (7) for receiving objects to be treated, a drum holder (9) into which the drum (6) can be inserted, a drive unit (10) designed to drive the drum (6) inserted into the drum holder (9) in rotation about an axis of rotation (X) relative to the drum holder (9), and a pivoting unit (11) holding the drum holder (9), which is designed to arrange the drum holder (9) in different pivoting positions by pivoting it about a pivot axis (S), the pivoting positions comprising a loading position, in which the drum (6) can be inserted vertically from above into the drum holder (9) and removed vertically upwards from it, and a working position, in which the drum holder (9) is tilted relative to the loading position by a first pivoting angle (α₁) to the vertical (V), which is in particular in a range between 30° and 60°, and
an irradiation unit (4) which is arranged and designed to introduce radiation into the receiving space (8) of the drum (6) received in the drum holder (9) in the working position of the drum holder (9) and thus to treat surfaces of the objects introduced into the receiving space (8),
wherein the irradiation unit (4) is held on an articulated arm robot (3) or on a multi-axis linear system (14) and is movable relative to the receiving unit (2).

2. The device (1) according to claim 1, wherein the treatment is a surface cleaning and/or surface roughening treatment.

3. The device (1) according to claim 1, wherein the objects are bulk goods.

4. The device (1) according to claim 1, wherein the axis of rotation (X) runs centrally through the drum opening (7) of the drum (6) inserted into the drum holder (9) and, in particular, is aligned perpendicular to a plane of the drum opening (7).

5. The device (1) according to claim 1, wherein the pivot axis (S) extends horizontally.

6. The device (1) according to claim 1, wherein the pivot axis (S) and the axis of rotation (X) are perpendicular to each other.

7. The device (1) according to claim 1, wherein the pivoting positions comprise an unloading position in which the drum holder (9) is tilted relative to the loading position by a second pivoting angle (α₂) to the vertical (V), wherein the second pivoting angle (α₂) lies in particular in a range between 150° and 210°.

8. The device (1) according to claim 1, wherein the irradiation unit (4) has at least one radiation source, which is designed in particular as a laser beam source.

9. The device (1) according to claim 8, wherein each radiation source comprises an associated optical system.

10. The device (1) according to claim 1, wherein the receiving unit (2) has an extraction unit (12) for extracting process vapors from the receiving space (8) of the drum (6) received in the drum holder (9).

11. Device (1) according to claim 1, wherein it has a protective cabin (5) accessible from above, inside which the receiving unit (2), the irradiation unit (4) and the articulated arm robot (3) are arranged.

12. The device (1) according to claim 2, wherein the objects are bulk goods.

13. The device (1) according to claim 2, wherein the axis of rotation (X) runs centrally through the drum opening (7) of the drum (6) inserted into the drum holder (9) and, in particular, is aligned perpendicular to a plane of the drum opening (7).

14. The device (1) according to claim 3, wherein the axis of rotation (X) runs centrally through the drum opening (7) of the drum (6) inserted into the drum holder (9) and, in particular, is aligned perpendicular to a plane of the drum opening (7).

15. The device (1) according to claim 2, wherein the pivot axis (S) extends horizontally.

16. The device (1) according to claim 3, wherein the pivot axis (S) extends horizontally.

17. The device (1) according to claim 4, wherein the pivot axis (S) extends horizontally.

18. The device (1) according to claim 2, wherein the pivot axis (S) and the axis of rotation (X) are perpendicular to each other.

19. The device (1) according to claim 3, wherein the pivot axis (S) and the axis of rotation (X) are perpendicular to each other.

20. The device (1) according to claim 4, wherein the pivot axis (S) and the axis of rotation (X) are perpendicular to each other.
